(19) United States
(12) Patent Application Publication
(10) Pub. No.: US 2011/0061024 A1
(43) Pub. Date: Mar. 10, 2011

(54) ELECTRONIC DEVICE AND METHOD FOR ACCESSING WEATHER INFORMATION

(75) Inventors: Chia-Peng WANG, Tu-Cheng (TW); Tien-Ping LIU, Tu-Cheng (TW)

(73) Assignee: HON HAI PRECISION INDUSTRY CO., LTD., Tu-Cheng (TW)

(21) Appl. No.: 12/629,605

(22) Filed: Dec. 2, 2009

(30) Foreign Application Priority Data
Sep. 9, 2009 (CN) 200910306769.5

(51) Int. Cl. G06F 3/048; G06F 17/30

(52) U.S. Cl. 715/816; 707/769; 707/E17.014

(57) ABSTRACT

An electronic device can access weather information via a network. The electronic device includes a graphical user interface (GUI) module, a weather service management module, a download module and a display. The GUI module can process and transmit input of letters. The weather service management module can build and modify a city result list from an available city list according to the input from the GUI module, when the input letters reach a predetermined number. The selected city is selected from the city result list by user input to the GUI module, and the download module can get weather content of a selected city. The display can display the weather content for the selected city.

### BACKGROUND

1. Technical Field

The present disclosure relates to electronic devices and methods for accessing weather information with the electronic device.

2. Description of Related Art

With so many cities in the world, accessing weather information for a particular city using the Internet requires entering the full name of the city and possibly additional information such a zip code or country. Sometimes, after entering all the information it turns out the weather information for that particular city is not even available.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an electronic device communicating with weather service via a network, in accordance with an embodiment.

FIG. 2 is a block diagram of the electronic device of the embodiment of FIG. 1.

FIG. 3 is a flow chart of an embodiment of a method for accessing weather information through a weather service using the electronic device.

FIG. 4 is similar to FIG. 3, but is shown in another form.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

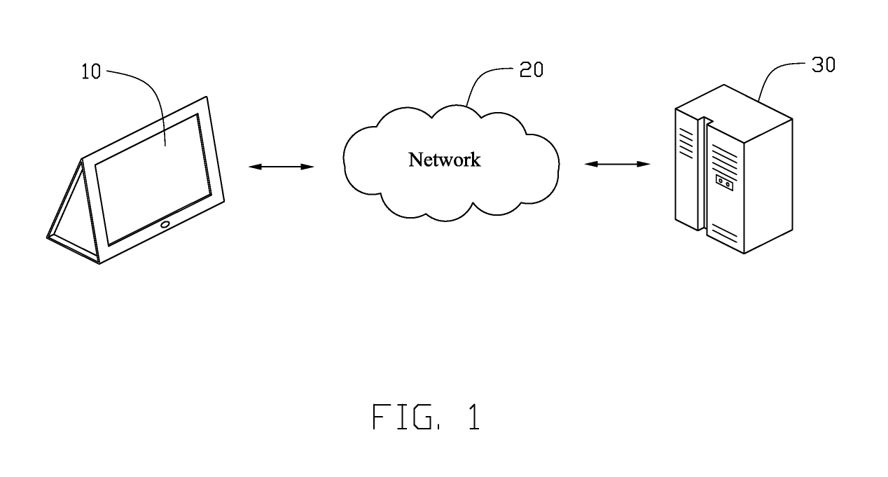

FIG. 1 illustrates an electronic device 10, in accordance with an embodiment, communicating with a weather service 30 via a network 20. In one embodiment, the electronic device 10 may be a digital photo frame. The weather service 30 can provide immediate current weather information. The network 30 may be the Internet.

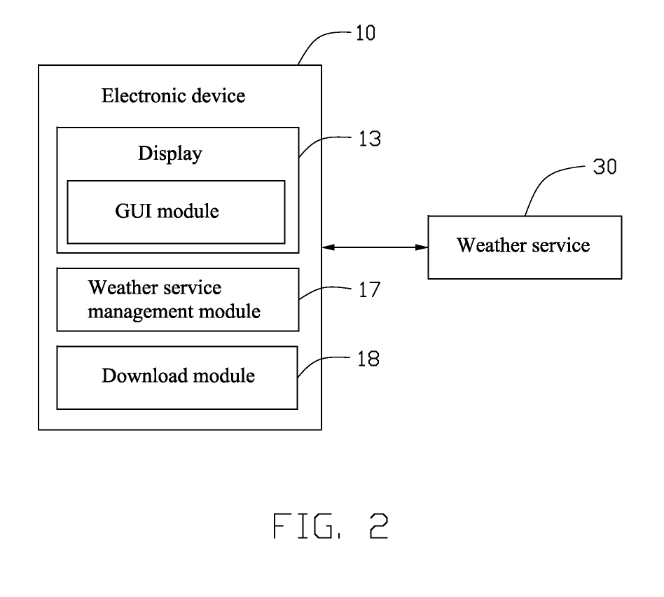

FIG. 2 illustrates the electronic device 10 communicating with the weather service 30. The electronic device 10 includes a display 13, a graphical user interface (GUI) module 133, a weather service management module 17, and a download module 18.

A GUI application is installed in the GUI module 133. The GUI application can accept input regarding weather service queries, in one embodiment, the GUI module 133 can process and transmit input of letters. The GUI application module 133 transmits each input of letters to the weather service management module 17.

The weather service management module 17 can build and modify a city result list from an available city list according to the input from the GUI module 133, when the input of letters reach a predetermined number. For example, if the predetermined number is three and a user is inputting “Boulder”, then a list is produced, once b-o-u are input, containing available cities whose names begin with b-o-u then the list is modified when 1 is entered showing only those available cities whose names begin with b-o-u-1 and so on. The predetermined number can also be calculated by the weather service management module 17 according to a processing capability of the electronic device. The weather service management module 17 can acquire the available city list from the network before building the city result list.

The download module 18 can get weather content of a selected city. The selected city is selected from the city result list by user input to the GUI module 133.

The display 13 can display the weather content.

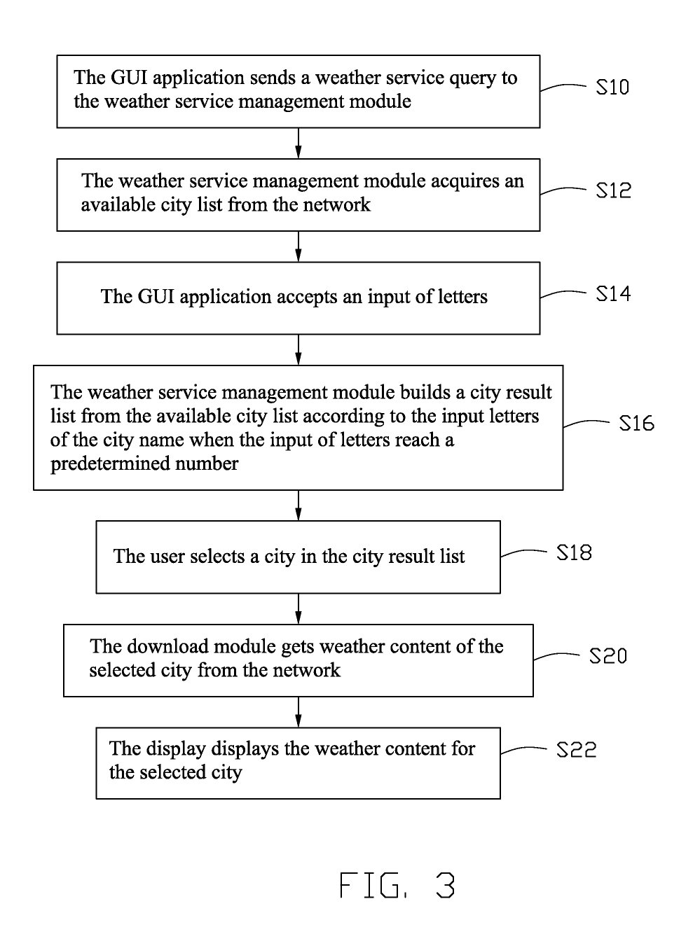

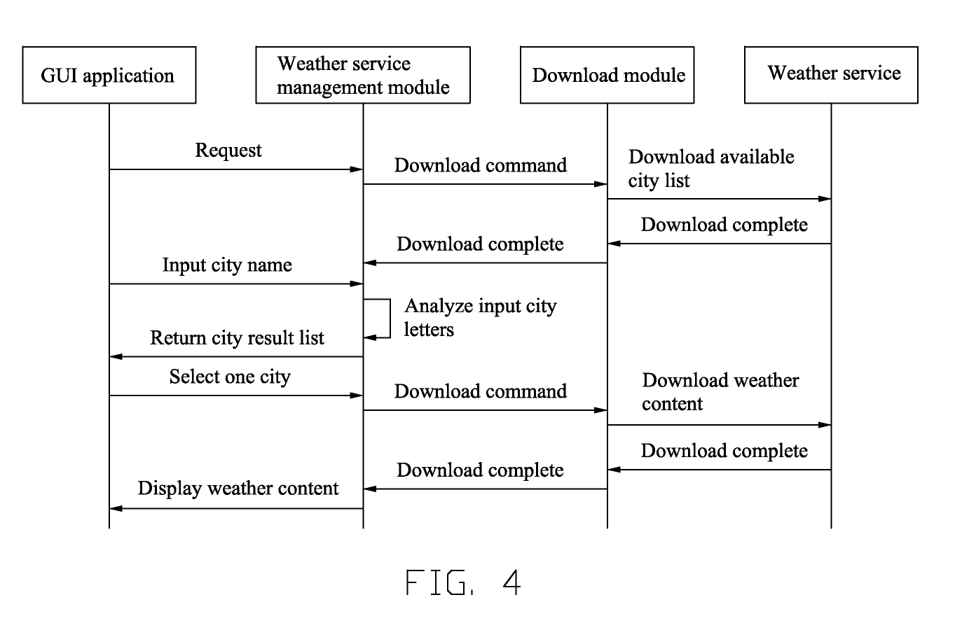

FIG. 3 and FIG. 4 illustrate flow charts of a method for getting weather service in the electronic device 10 via the network 20, in accordance with one embodiment.

In block S10, the GUI application sends a weather service query to the weather service management module 17.

In block S12, the weather service management module 17 acquires an available city list from the network 20.

In block S14, the GUI application accepts an input of letters.

In block S16, the weather service management module 17 builds a city result list from the available city list according to the input letters of the city name when the input of letters reach a predetermined number, the weather service management module 17 modifies the city list if input continues.

In block S18, the user selects a city in the city result list.

In block S20, the download module 18 gets weather content of the selected city from the network 20. The weather service management module 17 can send a download address to the download module 18 before the download module 18 gets the weather content.

In block S22, the display 13 displays the weather content for the selected city.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is also to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An electronic device capable of accessing weather information via a network, the electronic device comprising:
a graphical user interface (GUI) module capable of processing and transmitting input of letters;
a weather service management module that is capable of building and modifying a city result list from an available city list according to the input from the GUI module, when the input of letters reach a predetermined number;
a download module capable of getting weather content of a selected city wherein the selected city is present on the city result list; and
a display capable of displaying the weather content for the selected city.

2. The electronic device of claim 1, wherein the predetermined number is three.

3. The electronic device of claim 1, wherein the predetermined number is calculated by the weather service management module according to a processing capability of the electronic device.

4. The electronic device of claim 1, the GUI module provides a GUI application to accept input.

5. The electronic device of claim 4, the GUI module is capable of transmitting the each input of letters to the weather service management module.

6. The electronic device of claim 1, wherein the weather service management module is capable of acquiring the available city list from the network before building the city result list.

7. A method for accessing weather information in an electronic device via a network, the method comprising:
sending a weather service query to a weather service management module from a graphical user interface (GUI) application;
acquiring an available city list from the network by the weather service management module;
accepting an input of letters using the GUI application;
building a city result list from the available city list by the weather service management module according to the input of letters when the input letters reach a predetermined number;
acquiring a selected city in the city result list;
getting weather content of the selected city from the network by a download module; and
displaying the weather content on a display.

8. The method of claim 7 further comprising transmitting the weather service query as each letter is input to the weather service management module.

9. The method of claim 7, wherein the predetermined number is calculated by the weather service management module according to a processing capability of the electronic device.

10. The method of claim 7, wherein the predetermined number is three.

11. The method of claim 7 further comprising sending a download address to the download module by the weather service management module before the download module gets the weather content.

12. A method for accessing weather information in an electronic device via a network, the method comprising:
providing a graphical user interface (GUI) module, the graphical user interface (GUI) module capable of processing and transmitting input of letters; a weather service management module that is capable of building and modifying a city result list from an available city list according to the input from the GUI module when the input of letters reach a predetermined number; a download module capable of getting weather content of a selected city; and a display capable of displaying the weather content for the selected city;
sending a weather service query to a weather service management module from a graphical user interface (GUI) application;
acquiring an available city list from the network by the weather service management module;
accepting an input of letters using the GUI application;
building a city result list from the available city list by the weather service management module according to the input of letters when the input letters reach a predetermined number;
acquiring a selected city in the city result list;
getting weather content of the selected city from the network by a download module; and
displaying the weather content on a display.
